(19) United States
(12) Patent Application Publication
(10) Pub. No.: US 2008/0189072 A1
(43) Pub. Date: Aug. 7, 2008

(54) High resolution encoder within a swivel

(75) Inventor: Paul S. Cardello, West Chester, PA (US)

Correspondence Address: RATNERPRESTIA, P O BOX 980, VALLEY FORGE, PA, 19482-0980, US

(73) Assignee: Nescom Inc.

(21) Appl. No.: 11/700,983

(22) Filed: Feb. 1, 2007

(51) Int. Cl. G01B 21/00

(52) U.S. Cl. 702/158

(57) ABSTRACT

A rotational positioning system is disclosed. The rotational position system includes a housing, a body rotatable with respect to the housing, and a target eccentrically mounted on the body. A first sensor is mounted on the housing. The first sensor is adapted to transmit a first signal based on a distance of the target relative to the first sensor. The first signal varies according to a rotational position of the body with respect to the housing. A processor is electrically coupled to the first sensor and is adapted to read the first signal from the first sensor. A method of determining a rotational position of a body relative to a fixed point is also disclosed.

### FIELD OF THE INVENTION

The present invention relates to an apparatus and method for determining the position of a rotatable body relative to a fixed point.

### BACKGROUND OF THE INVENTION

Aerials are rotatably mounted on vehicles to enable operations to be performed from the vehicle at locations where the vehicle might not otherwise be able to reach. Such examples of vehicle-mounted aerials are firefighting vehicles with extension ladders and electrical service and tree trimming vehicles, which use rotatable devices, such as ladders, platforms or buckets (cherry-pickers) to maneuver firefighters and workers above and around the vehicles. While such aerials are free to theoretically rotate on their swivels in a complete circle, physical impediments, such as the vehicle cab, may preclude rotation through specific arcs. Other situations, such as the failure to deploy outrigger stabilizers, may also give rise to a need to preclude rotation of the aerial about a specific arc.

By sensing the rotation of the aerial during manual control operation with, for example, proximity switches and target plates, the direction of rotation and the approach to various critical points can be sensed, so that the aerial will be rotated only into a clear area.

While an operator of the aerial needs to know when the aerial is approaching a critical location, the operator does not necessarily need to know the exact rotational position of the aerial relative to the vehicle body. An approximate rotational position of the aerial relative to the vehicle body is generally sufficient to provide the operator with information required to determine when the aerial is approaching a critical location.

Presently, an optical encoder (typically a 12 bit optical device) is mounted to the swivel and is connected to the swivel by belts or gears so that rotation of the swivel rotates the encoder shaft. The encoder outputs a signal that represents the rotational position of the aerial. Disadvantages of the present configuration include complexity (additional mechanical components are required); cost; inability to physically protect the encoder within the swivel housing, resulting in damage due to obstructions and/or jamming of the belts or gears, and/or formation of ice on the encoder; and increased size (may not fit into available space).

It would be beneficial to provide a device that can provide an accurate position of an aerial relative to its vehicle body and that does not include the disadvantages described above.

### SUMMARY OF THE INVENTION

Briefly, the present invention provides a rotational positioning system. The rotational position system includes a housing, a body rotatable with respect to the housing, and a target eccentrically mounted on the body. A first sensor is mounted on the housing. The first sensor is adapted to transmit a first signal based on a distance of the target relative to the first sensor. The first signal varies according to a rotational position of the body with respect to the housing. A processor is electrically coupled to the first sensor and adapted to read the first signal from the first sensor.

Additionally, the present invention provides a rotational positioning system comprising a housing, a body rotationally mounted with respect to the housing, and a first sensor coupled to one of the housing and the body. The first sensor is adapted to transmit a signal based on a rotational position of the body relative to the housing. A processor is electrically coupled to the first sensor to determine the rotational position of the body with respect to the housing based on the signal transmitted by the first sensor.

Also, the present invention provides a rotational positioning system for determining a rotational position of a swivel relative to a fixed point comprising means for obtaining a first position value, means for obtaining a second position value, means for determining a rotational position value based on the first position value and the second position, and means for determining the rotational position of the body relative to the fixed point based on the rotational position value.

Further, the present invention provides a method for use with a first sensor and a second sensor of determining a rotational position of a body relative to a fixed point comprising: obtaining a first output value from the first sensor; obtaining a second output value from the second sensor; determining a rotational position value based on the first output value and the second output value; and determining the rotational position of the body relative to the fixed point based on the rotational position value.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain features of the invention. In the drawings:

FIG. 1 is a perspective view of a swivel assembly according to an exemplary embodiment of the present invention, with a body located within a housing;

FIG. 2 is a schematic view of the swivel assembly of FIG. 1, with a target on the body located relative to the housing at a location defined as zero degrees;

FIG. 3 is a schematic view of the swivel assembly of FIG. 1, with the target on the body located relative to the housing at a location defined as 180 degrees;

FIG. 4 is a combined graph comparing a modified cosine curve with calculated results and showing the difference between the values of the modified cosine curve and the calculated results;

FIG. 5 is a flow chart showing operation of the resolver of the present invention;

FIG. 6 is a graph showing calculated values for rotations from zero to 360 degrees; and corresponding adjustments made to the calculated values; and

FIG. 7 is a graph showing measured values for actual test results, and corresponding adjustments made to the measured values.

### DETAILED DESCRIPTION OF THE INVENTION

Certain terminology is used in the following description for convenience only and is not limiting. The terminology includes the words above specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Referring to the figures generally, a swivel assembly 100 according to an embodiment of the present invention is shown. Swivel assembly 100 is used in conjunction with a motor (not shown) to rotate an aerial (not shown) relative to a base.

While an exemplary embodiment that employs an aerial is aerial firefighting equipment rotatably positioned on a fire truck, such as a ladder or water cannon, those skilled in the art will recognize that other types of non-firefighting equipment, such as cranes and utility truck cherry pickers, may be rotatably mounted to a base, and fall within the scope of the present invention.

An encoder system is incorporated into swivel assembly 100 to determine the rotated position of the aerial relative to the base.

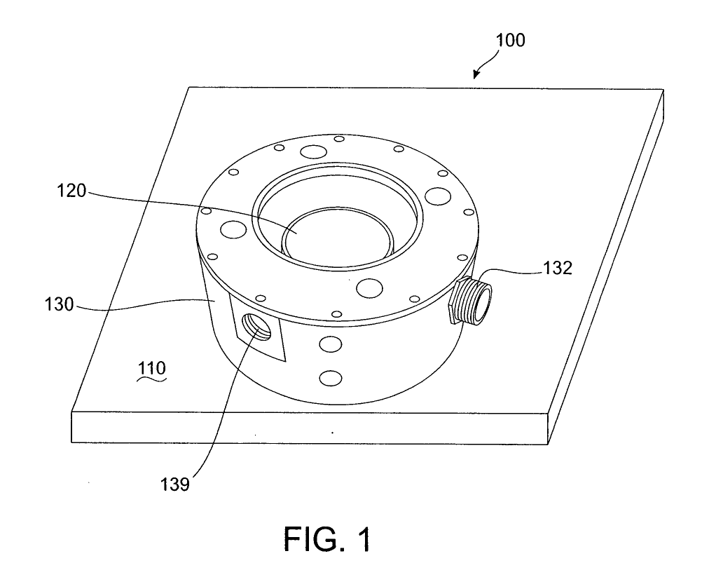

Referring in particular now to FIG. 1, swivel assembly 100 is rotatably mounted to a base 110. Swivel assembly includes a body 120 and a housing 130. Body 120 is rotatable with respect to housing 130 and may be operated by an electrical or hydraulic motor (not shown). Body 120 is mounted within a periphery of housing 130 that is coupled to base 110 such that housing 130 is fixed relative to base 110 during rotation of body 120. An aerial (not shown) is mounted to body 120 and rotates with body 120 to allow a user (not shown) to operate aerial as body 120 rotates about base 110. A target 122 is eccentrically mounted on body 120. Target 122 is used to determine the rotational position of body 120 relative to housing 130.

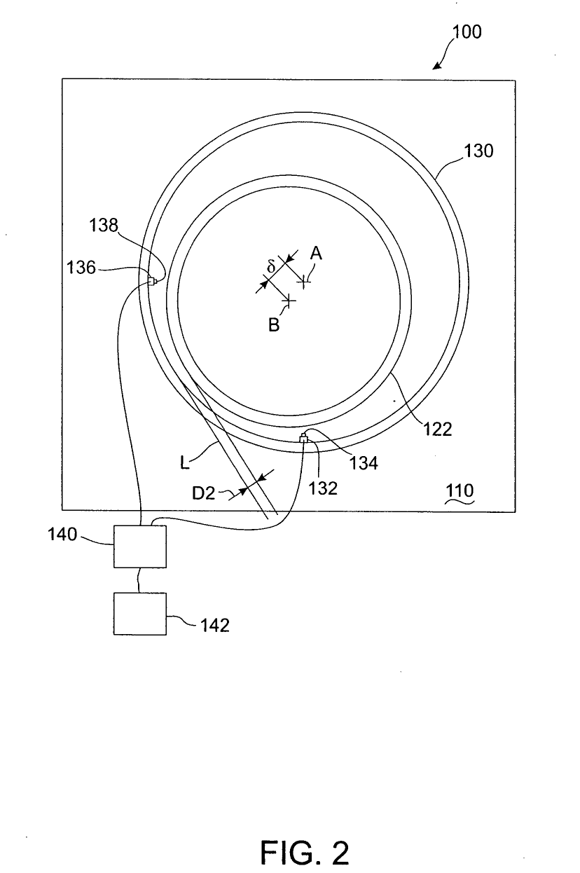

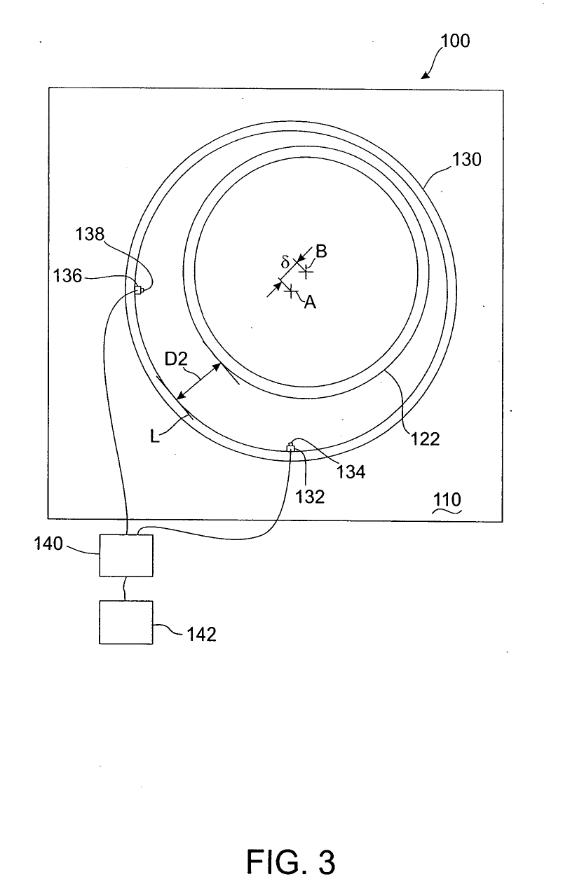

Referring to FIGS. 2 and 3, housing 130 has a center “A” and target 122 has a rotational center “B” that is eccentrically offset from center “A” by an offset δ. Body 120 is not shown in either of FIGS. 2 or 3 for clarity. Body 120, however also has a center “A” such that body 120 is mounted coaxially with respect to housing 130. Target 122 is fixedly mounted to body 120 such that rotation of body 120 also rotates target 122, albeit eccentrically with respect to body 120. Target 122 is shown in FIGS. 2 and 3 as an annular ring, although those skilled in the art will recognize that target 122 may be other shapes.

In an exemplary embodiment, offset δ is approximately 0.50 inch (1.27 cm). This offset provides an eccentric rotation of target 122 with respect to housing 130. Consequently, for a 180 degree rotation of target 122 with respect to housing 130, the distance between a point on housing 130 and target 122 may vary up to 2δ, or approximately one inch (2.54 cm).

In another exemplary embodiment, offset δ may be approximately 0.1 inch (0.25 cm) such that the distance between a point on housing 130 and target 122 may vary up to 2δ, or approximately 0.2 inch (0.50 cm). A distance δ of approximately 0.1 inch provides a more linear result than the larger distance δ of approximately 0.5 inch when calculating rotation of swivel 120 relative to housing 130.

A first sensor 132 is mounted onto housing 130 such that a first sensing portion 134 extends from housing 130 toward target 122. A second sensor 136 may be mounted onto housing 130 approximately 90 degrees around a circumference of housing 130 from first sensor 132 such that a second sensing portion 138 extends from housing 130 toward target 122. Second sensor 136 may be omitted without departing from the spirit and scope of the present invention, although the present invention will be described as incorporating second sensor 136.

First and second sensors 132 and 136 are removably mounted onto housing 130 so that first and second sensors 132 and 136 may be easily removed from housing 130, such as for maintenance or replacement. For example, first and second sensors 132 and 136 may each be threadedly mounted to housing 130. FIG. 1 shows a threaded opening 139 to receive second sensor 138 (not shown). Referring back to FIGS. 2 and 3, first and second sensors 132 and 136 may be 12 bit encoders and are electrically coupled to a processor 140, which is adapted to read and process signals transmitted from each of first and second sensors 132 and 136.

In the exemplary embodiment, sensors 132 and 136 are inductive proximity sensors. However, other types of sensors, such as potentiometer sensors or other sensors utilizing a cam sensor may be used.

In one embodiment, first and second sensors 132 and 136 sense the distance of target 122 relative to first and second sensors 132 and 136, respectively, as target 122 eccentrically rotates relative to housing 130. First and second sensors 132 and 136 each transmit a separate voltage signal to processor 140 based on a distance of target 122 relative to each of first and second sensors 132 and 136. The signals transmitted by first and second sensors 132 and 136 vary according to a rotational position of body 120 with respect to a predetermined location relative to housing 130. Based on the voltage signals received from each of first and second sensors 132 and 136, processor 140 determines a rotational position of body 120 with respect to housing 130. In certain circumstances, each 180 degree arc of rotation of target 122 may generate signal values that are repeated during a second 180 degree arc of rotation. In such circumstances, in an alternative embodiment of the present invention, first sensor 132 senses the distance of target 122 relative to first sensor 132 as target 122 eccentrically rotates relative to housing 130. Second sensor 136 can be configured to sense which of the two 180 degree arcs is applicable, such as by sensing increasing or decreasing voltage values and transmitting an appropriate signal to processor 140. Alternatively, processor 140 may compare successive values transmitted by first sensor 132 to calculate increasing or decreasing voltage values and determine the direction of rotation and location of target 122 relative to housing 130 based on such values.

While FIG. 1 shows first sensor 132 attached to the side of housing 130, those skilled in the art will recognize that first sensor 132 (and second sensor 136, not shown) may be attached to the top of housing 130, with an appropriate change in the configuration of target 122. In the exemplary embodiment shown, body 120 and target 122 are the only elements fully internal to housing 130, with first and second sensors 132 and 136, respectively, removable from the outside of housing 130 to 30 facilitate maintenance and/or replacement.

In an alternative embodiment (not shown), first and second sensors 132 and 136 may be mounted on body 120, with target 122 eccentrically mounted on housing 130.

Because target 122 rotates about its rotational center “B”, a sine-like rotational curve is generated as target 122 rotates relative to housing 130. Because target 122 is offset from center “A” of housing 130 by offset δ, however, the curve is not a pure sine wave. In an effort to quantify the difference between a true resolver using pure sine functions and the resolver of the present invention that is sine-like, but due to offset δ of target 122 relative to housing 130, does not generate a pure sine wave, adjustments may be made to the values obtained by first and second sensors 132 and 136 to approximate a sine function and, consequently, determine the rotational location of target relative to base 110 in degrees. Also, swivel assembly 100 may be calibrated against an external reference encoder (not shown), which is later removed, allowing processor 140 to calculate angular values in degrees to an accuracy, resolution, and repeatability comparable to commercially available high resolution 12-bit optical encoders.

The following describes the embodiment discussed above in which first and second sensors 132 and 136 each sense the distance of target 122 relative to first and second sensors 132 and 136, respectively, as target 122 eccentrically rotates relative to housing 130. For a swivel assembly 100 having offset δ at 0.50 inches, body 120 and target 122 are rotated with respect to housing 130. In this exemplary embodiment, shown schematically in FIG. 2, a rotational angle of zero (0) degrees is determined when target 122 was farthest from housing 130 at a point halfway between first sensor 132 and second sensor 136. At that point, the perpendicular distance D1 between target 122 and a line “L” tangent to housing 130 is 4.50 inches (approximately 11.43 cm). The gap at this location is determined to be 0 inches.

As body 120 and target 122 are rotated 180 degrees to the location shown in FIG. 3, the perpendicular distance D2 between target 122 and line L decreases to 3.50 inches (approximately 8.89 cm). The gap at this location is determined to be approximately 1.00 inch (4.50-3.50 inches). Calculated gap measurements in increments of 10 degree rotations of target 122 with respect to base 110 are provided in Table I below.

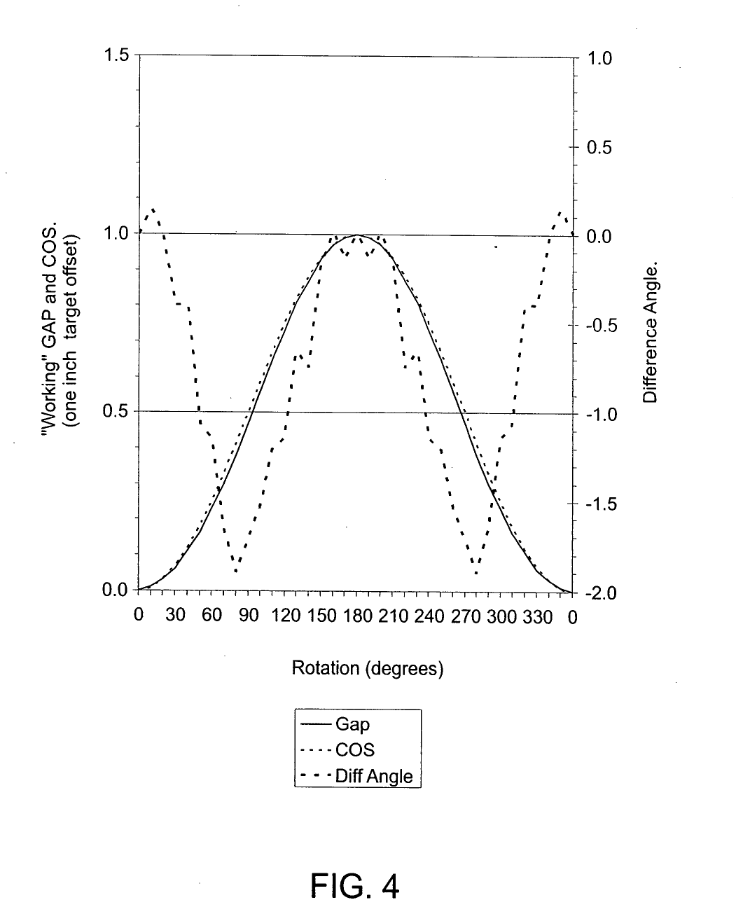

COS values are determined by scaling a calculated cosine-like curve by a factor of 0.5 and shifting the curve up an offset of 0.5 to provide a cosine curve having values ranging between 0.0 and 1.0 to correspond to the gap values also between 0 and 1.0, as reflected in the third column of Table I as well as in FIG. 4.

Referring to the fourth column of Table I, difference angle θ is the difference between the read angle and the true angle. Angles are used in the presented data for convention and for comparison with a commercially available optical encoder used as a reference, to establish the resolution and repeatability of the invention. Difference angle θ varies between 0 and 1.9 degrees between a scaled pure cosine function and,the cosine-like function generated as a result of offset δ. FIG. 4 shows a comparison of calculated gap distances and the modified cosine curve. The read angle differs from the true angle because of offset δ, as well as other minor factors, such as the roundness of swivel 120, which may alter the location of target 122 with respect to sensors 132 and 136, as well as non-linearities in sensors 132 and 136. A maximum difference angle θ of approximately −1.9 degrees is calculated at approximately 80 degrees of rotation, and again at approximately 280 degrees of rotation, with an average difference angle θ of approximately 0.5 degrees.

TABLE I

| Rotation | | | Difference | | Distance (1″ |
|---|---|---|---|---|---|
| angle | Gap | COS | Angle θ | Difference | offset |
| 0 | 0.0000 | 0.0000 | 0.00 | 0.000 | 4.50 |
| 10 | 0.0100 | 0.0076 | 0.14 | −0.002 | 4.49 |
| 20 | 0.0300 | 0.0302 | −0.01 | 0.000 | 4.47 |
| 30 | 0.0600 | 0.0670 | −0.40 | 0.007 | 4.44 |
| 40 | 0.1100 | 0.1170 | −0.40 | 0.007 | 4.39 |
| 50 | 0.1600 | 0.1786 | −1.07 | 0.019 | 4.34 |
| 60 | 0.2300 | 0.2500 | −1.15 | 0.020 | 4.27 |
| 70 | 0.3000 | 0.3290 | −1.66 | 0.029 | 4.20 |
| 80 | 0.3800 | 0.4132 | −1.90 | 0.033 | 4.12 |
| 90 | 0.4700 | 0.5000 | −1.72 | 0.030 | 4.03 |
| 100 | 0.5600 | 0.5868 | −1.54 | 0.027 | 3.94 |
| 110 | 0.6500 | 0.6719 | −1.20 | 0.021 | 3.85 |
| 120 | 0.7300 | 0.7500 | −1.15 | 0.020 | 3.77 |
| 130 | 0.8100 | 0.8214 | −0.65 | 0.011 | 3.69 |
| 140 | 0.8700 | 0.8830 | −0.75 | 0.013 | 3.63 |
| 150 | 0.9300 | 0.9330 | −0.17 | 0.003 | 3.57 |
| 160 | 0.9700 | 0.9698 | 0.01 | 0.000 | 3.53 |
| 170 | 0.9900 | 0.9924 | −0.14 | 0.002 | 3.51 |
| 180 | 1.0000 | 1.0000 | 0.00 | 0.000 | 3.50 |
| 190 | 0.9900 | 0.9924 | −014 | 0.002 | 3.51 |
| 200 | 0.9700 | 0.9698 | 0.01 | 0.000 | 3.53 |
| 210 | 0.9300 | 0.9330 | −0.17 | 0.003 | 3.57 |
| 220 | 0.8700 | 0.8830 | −0.75 | 0.012 | 3.63 |
| 230 | 0.8100 | 0.8214 | −0.65 | 0.011 | 3.69 |
| 240 | 0.7300 | 0.7500 | −1.15 | 0.020 | 3.77 |
| 250 | 0.6500 | 0.6710 | −1.20 | 0.027 | 3.85 |
| 260 | 0.5600 | 0.5868 | −1.54 | 0.030 | 3.94 |
| 270 | 0.4700 | 0.5000 | −1.72 | 0.033 | 4.03 |
| 280 | 0.3800 | 0.4132 | −1.90 | 0.02 | 4.12 |
| 290 | 0.3000 | 0.3290 | −1.66 | 0.029 | 4.20 |
| 300 | 0.2300 | 0.2500 | −1.15 | 0.020 | 4.27 |
| 310 | 0.1600 | 0.1786 | −1.07 | 0.019 | 4.34 |
| 320 | 0.1100 | 0.1170 | −0.40 | 0.007 | 4.39 |
| 330 | 0.0600 | 0.0670 | −0.40 | 0.007 | 4.44 |
| 340 | 0.0300 | 0.0302 | −0.01 | 0.000 | 4.47 |
| 350 | 0.0100 | 0.0076 | 0.14 | −0.002 | 4.49 |
| 0 | 0.0000 | 0.0000 | 0.00 | 0.000 | 4.50 |

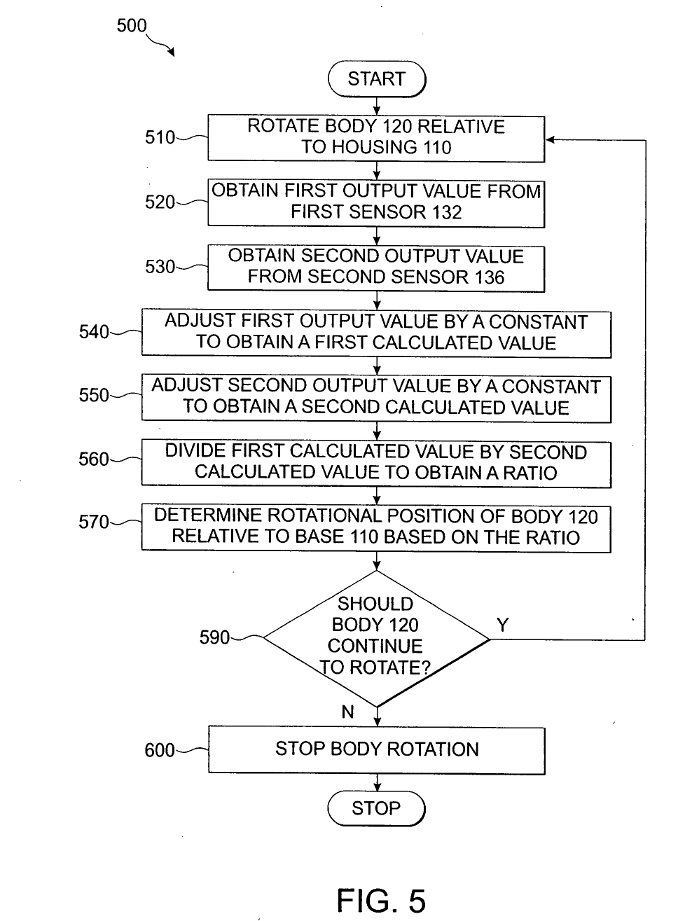

To obtain rotation information of target 122 from sensors 132 and 136, which are physically mounted 90 degrees apart from each other on housing 130, a pure sine output from each of first and second sensors 132 and 136 that varies between ±1 is assumed. In step 510 of flow chart 500 shown in FIG. 5, body 120 (and target 122) is rotated relative to housing 110.

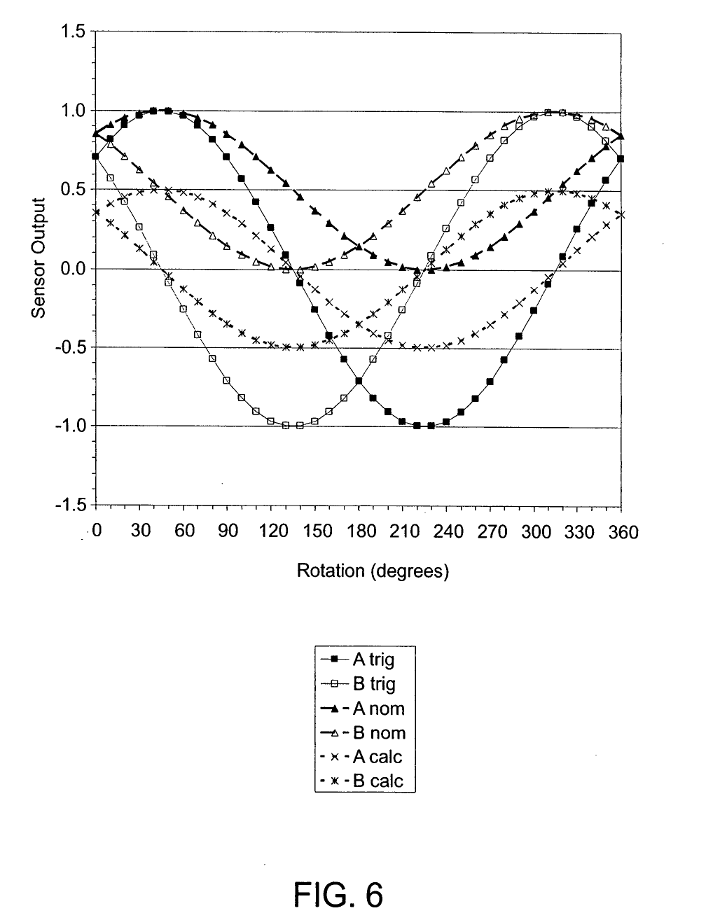

Referring to Table II below, steps 520 and 530 of flow chart 500 shown in FIG. 5, and FIG. 6, calculated sine wave values are shown as “A trig” (for first sensor 132) and “B trig” (for second sensor 136). The columns “A nom” and “B nom” adjust “A trig” and “B trig”, respectively, by scaling the actual sine curves by a factor of 0.5 and shifting the curve up an offset of 0.5 to provide sine curves having values ranging between 0.0 and 1.0. The scaled and shifted values are provided as “A nom” and “B nom” in the fourth and fifth columns of Table II, as well as in FIG. 6. Next, in steps 540 and 550 of the flow chart shown in FIG. 5 and shown in the sixth and seventh columns of Table II, as well as FIG. 6, “A calc” and “B calc” are derived from “A nom” and “B nom”, respectively, by subtracting 0.500 from each value. The number 0.500 was chosen so that the values varied between 0 and ±0.5. This results in unique values of A/B calc for the full rotational range of 360 degrees. It should be noted that only the values between 0 and 51 are shown to limit the length of the table. Those skilled in the art will recognize that angular values between 52 and 360 degrees may be calculated in a similar manner.

TABLE II

| | | | | | | | | Aerial |
|---|---|---|---|---|---|---|---|---|
| Degrees | A trig | B trig | A nom | B nom | A calc | B calc | A/B calc | Rotation |
| 0 | 0.707 | 0.707 | 0.854 | 0.854 | 0.354 | 0.354 | 1.00 | 0.0 |
| 1 | 0.719 | 0.695 | 0.860 | 0.847 | 0.360 | 0.347 | 1.04 | 1.0 |
| 2 | 0.731 | 0.682 | 0.866 | 0.841 | 0.366 | 0.341 | 1.07 | 2.0 |
| 3 | 0.743 | 0.669 | 0.872 | 0.835 | 0.372 | 0.335 | 1.11 | 3.0 |
| 4 | 0.755 | 0.656 | 0.877 | 0.828 | 0.377 | 0.328 | 1.15 | 4.0 |
| 5 | 0.766 | 0.643 | 0.883 | 0.821 | 0.383 | 0.321 | 1.19 | 5.0 |
| 6 | 0.777 | 0.629 | 0.889 | 0.815 | 0.389 | 0.315 | 1.23 | 6.0 |
| 7 | 0.788 | 0.616 | 0.894 | 0.808 | 0.394 | 0.308 | 1.28 | 7.0 |
| 8 | 0.799 | 0.602 | 0.899 | 0.801 | 0.399 | 0.301 | 1.33 | 8.0 |
| 9 | 0.809 | 0.588 | 0.905 | 0.794 | 0.405 | 0.294 | 1.38 | 9.0 |
| 10 | 0.819 | 0.574 | 0.010 | 0.787 | 0.410 | 0.287 | 1.43 | 10.0 |
| 11 | 0.829 | 0.559 | 0.915 | 0.780 | 0.415 | 0.280 | 1.48 | 11.0 |
| 12 | 0.839 | 0.545 | 0.919 | 0.772 | 0.419 | 0.272 | 1.54 | 12.0 |
| 13 | 0.848 | 0.530 | 0.924 | 0.765 | 0.424 | 0.265 | 1.60 | 13.0 |
| 14 | 0.857 | 0.515 | 0.929 | 0.758 | 0.429 | 0.258 | 1.66 | 14.0 |
| 15 | 0.866 | 0.500 | 0.933 | 0.750 | 0.433 | 0.250 | 1.73 | 15.0 |
| 16 | 0.875 | 0.485 | 0.937 | 0.742 | 0.437 | 0.242 | 1.80 | 16.0 |
| 17 | 0.883 | 0.469 | 0.941 | 0.735 | 0.441 | 0.235 | 1.88 | 17.0 |
| 18 | 0.891 | 0.454 | 0.946 | 0.727 | 0.446 | 0.227 | 1.96 | 18.0 |
| 19 | 0.899 | 0.438 | 0.949 | 0.719 | 0.449 | 0.219 | 2.05 | 19.0 |
| 20 | 0.906 | 0.423 | 0.953 | 0.711 | 0.453 | 0.211 | 2.14 | 20.0 |
| 21 | 0.914 | 0.407 | 0.957 | 0.703 | 0.457 | 0.203 | 2.25 | 21.0 |
| 22 | 0.921 | 0.391 | 0.960 | 0.695 | 0.460 | 0.195 | 2.36 | 22.0 |
| 23 | 0.927 | 0.375 | 0.964 | 0.687 | 0.464 | 0.187 | 2.48 | 23.0 |
| 24 | 0.934 | 0.358 | 0.967 | 0.679 | 0.467 | 0.179 | 2.61 | 24.0 |
| 25 | 0.940 | 0.342 | 0.970 | 0.671 | 0.470 | 0.171 | 2.75 | 25.0 |
| 26 | 0.946 | 0.326 | 0.973 | 0.663 | 0.473 | 0.163 | 2.90 | 26.0 |
| 27 | 0.951 | 0.309 | 0.976 | 0.655 | 0.476 | 0.155 | 3.08 | 27.0 |
| 28 | 0.956 | 0.292 | 0.978 | 0.646 | 0.478 | 0.146 | 3.27 | 28.0 |
| 29 | 0.961 | 0.276 | 0.981 | 0.638 | 0.481 | 0.138 | 3.49 | 29.0 |
| 30 | 0.966 | 0.259 | 0.983 | 0.629 | 0.483 | 0.129 | 3.73 | 30.0 |
| 31 | 0.970 | 0.242 | 0.985 | 0.621 | 0.485 | 0.121 | 4.01 | 31.0 |
| 32 | 0.974 | 0.225 | 0.987 | 0.612 | 0.487 | 0.112 | 4.33 | 32.0 |
| 33 | 0.978 | 0.208 | 0.989 | 0.604 | 0.489 | 0.104 | 4.70 | 33.0 |
| 34 | 0.982 | 0.191 | 0.991 | 0.595 | 0.491 | 0.095 | 5.14 | 34.0 |
| 35 | 0.985 | 0.174 | 0.992 | 0.587 | 0.492 | 0.087 | 5.67 | 35.0 |
| 36 | 0.988 | 0.156 | 0.994 | 0.578 | 0.494 | 0.078 | 6.31 | 36.0 |
| 37 | 0.990 | 0.139 | 0.995 | 0.570 | 0.495 | 0.070 | 7.12 | 37.0 |
| 38 | 0.993 | 0.122 | 0.996 | 0.561 | 0.496 | 0.061 | 8.14 | 38.0 |
| 39 | 0.995 | 0.105 | 0.997 | 0.552 | 0.497 | 0.052 | 9.51 | 39.0 |
| 40 | 0.996 | 0.087 | 0.998 | 0.544 | 0.498 | 0.044 | 11.43 | 40.0 |
| 41 | 0.998 | 0.070 | 0.999 | 0.535 | 0.499 | 0.035 | 14.30 | 41.0 |
| 42 | 0.999 | 0.052 | 0.999 | 0.526 | 0.499 | 0.026 | 19.08 | 42.0 |
| 43 | 0.999 | 0.035 | 1.000 | 0.517 | 0.500 | 0.017 | 28.64 | 43.0 |
| 44 | 1.000 | 0.017 | 1.000 | 0.509 | 0.500 | 0.009 | 57.29 | 44.0 |
| 45 | 1.000 | 0.000 | 1.000 | 0.5000 | 0.500 | 0.000 | 50000.00 | 45.0 |
| 46 | 1.000 | −0.017 | 1.000 | 0.491 | 0.500 | −0.009 | −57.29 | 46.0 |
| 47 | 0.999 | −0.035 | 1.000 | 0.483 | 0.500 | −0.017 | −28.64 | 47.0 |
| 48 | 0.999 | −0.052 | 0.999 | 0.474 | 0.499 | −0.026 | −19.09 | 48.0 |
| 49 | 0.998 | −0.070 | 0.999 | 0.465 | 0.499 | −0.035 | −14.03 | 49.0 |
| 50 | 0.996 | −0.087 | 0.998 | 0.456 | 0.498 | −0.044 | −11.43 | 50.0 |
| 51 | 0.995 | −0.105 | 0.997 | 0.448 | 0.497 | −0.052 | −9.51 | 51.0 |

In step 560 of flow chart 500 of FIG. 5, a ratio of “A calc”/“B calc” (A/B calc) is next calculated. To avoid division by zero, a “B calc” value of zero is treated as “B calc”=0.00001. The arctan function is used to calculate the actual rotation angle, which is shown under the column heading “Aerial Rotation.” There is no difference between the values in the “Aerial Rotation” column and the “Calculations” column because equivalent mathematical adjustments were made to the same input data

In step 570 of flow chart 500 shown in FIG. 5, mathematical adjustments are made according to Equations 1-12 below to determine the rotational position of target 122 relative to base 110.

A nom=(A raw−A raw(min))/(A raw(max)−A raw(min)) Equation 1

IF(A nom<,>0), THEN A calc=A nom−0.5 Equation 2

IF(A nom=0), THEN A calc=0.00001(arbitrarily chosen to prevent division by zero) Equation 3

B nom=(B raw−B raw(min))/(B raw(max)−B raw(min)) Equation 4

IF(B nom<,>0), THEN B calc=B nom−0.5 Equation 5

IF(B nom=0), THEN B calc=0.00001(arbitrarily chosen to prevent division by zero) Equation 6

Typically, processor 140 will utilize the A nom and B nom ratios in determining the rotational position of the aerial. If a value, in degrees for example, is desired to evaluate resolution and repeatability against a reference encoder, the following equations may be used:

IF(A calc>=0 AND B calc>=0 AND A calc>=B calc), THEN A rot=ATAN(A calc/B calc)+Ap1 Equation 7

IF(A calc>=0 AND B calc>=0 AND A calc<=B calc), THEN A rot=ATAN(A calc/B calc)+Ap2 Equation 8

IF(A calc>=0 AND B calc>=0), THEN A rot=ATAN(A calc/B calc)+Ap3 Equation 9

IF(A calc<=0 AND B calc>=0), THEN A rot=ATAN(A calc/B calc)+Ap4 Equation 10

IF(A calc<=0 AND B calc<=0 AND A calc>=B calc), THEN A rot=ATAN(A calc/B calc)+Ap5 Equation 11

IF(A calc<=0 AND B calc<=0 AND A calc<=B calc), THEN A rot=ATAN(A calc/B calc)+Ap6 Equation 12

Where:

A calc=amplitude of A function (first sensor 132 output) after final adjusting calculations;

B calc=amplitude of B function (second sensor 136 output) after final adjusting calculations;

A rot=calculated angular rotation of aerial; and

Ap1-Ap6=phase angle correction constants. Phase angle correction constants Ap1-Ap6 are determined by the physical characteristics of each particular swivel assembly 100, including, for example, physical locations of first sensor 132 and second sensor 136, as well.

Table II shows increments of rotation of 1 degree between 0 and 51 degrees of rotation of target 122 with respect to housing 130. The values for A trig and B trig are determined by applying the appropriate SIN or COS function to the values shown in the “DEGREES” column.

### EXAMPLE

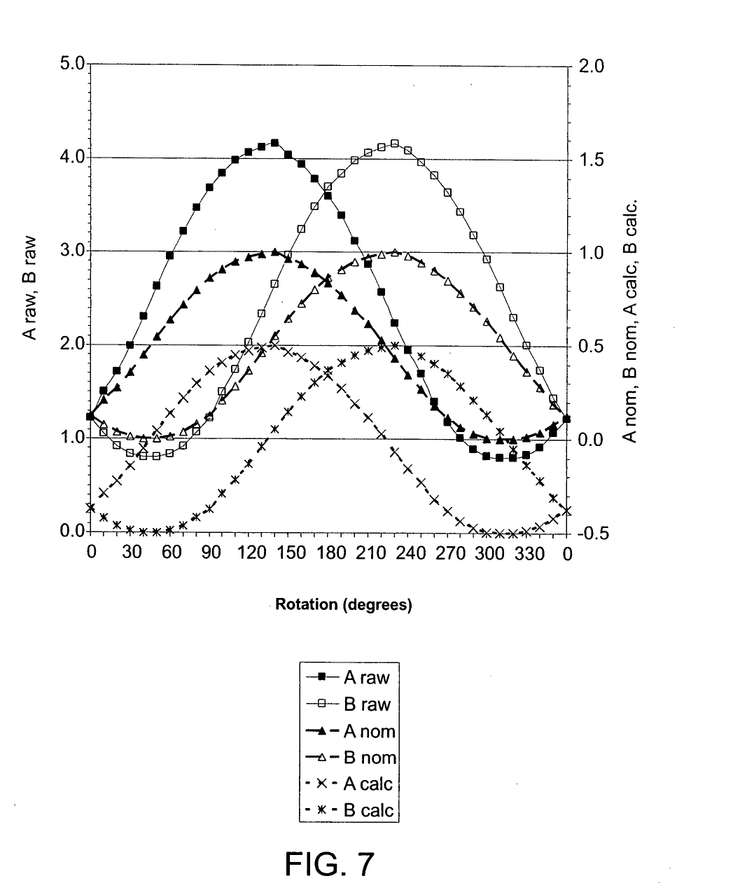

Table III below provides data from actual measurements and a comparison of rotational angle based on the actual measurements versus the actual angle of rotation. “A raw” and “B raw” represent a change in the gap between each respective sensor 132 and 136, and target 122 as body 120 and target 122 are rotated in ten degree increments. Values for “A nom,” “B nom,” “A calc,” “B calc,” and “A rot” are derived according to Equations 1-12 above. A graph of the values of “A raw,” “B raw,” “A nom,” “B nom,” “A calc,” “B calc,” and the resultant rotation are shown in the graph of FIG. 7.

The outputs of first sensor 132 and second sensor 136, respectively (A raw and B raw) are the only values used to determine the rotational position of body 120 relative to housing 130. The first column (“Degrees”) is the angular value generated by the external reference encoder.

TABLE III

| Degrees | A raw | B raw | A nom | B nom | A calc | B calc | A/B calc | A rot | Delta |
|---|---|---|---|---|---|---|---|---|---|
| 0 | 1.230 | 1.230 | 0.1277 | 0.1277 | −0.372 | −0.372 | 1.00 | 0.0 | 0.0 |
| 10 | 1.504 | 1.055 | 0.2093 | 0.0756 | −0.291 | −0.424 | 0.69 | 10.6 | 0.6 |
| 20 | 1.719 | 0.918 | 0.2733 | 0.0348 | −0.227 | −0.465 | 0.49 | 19.0 | −1.0 |
| 30 | 1.992 | 0.840 | 0.3546 | 0.0116 | −0.145 | −0.488 | 0.30 | 28.4 | −1.6 |
| 40 | 2.305 | 0.801 | 0.4478 | 0.0000 | −0.052 | −0.500 | 0.10 | 39.0 | −1.0 |
| 50 | 2.637 | 0.801 | 0.5466 | 0.0000 | 0.047 | −0.500 | −0.09 | 50.3 | 0.3 |
| 60 | 2.949 | 0.840 | 0.6395 | 0.0116 | 0139 | −0.488 | −0.29 | 60.9 | 0.9 |
| 70 | 3.223 | 0.918 | 0.7210 | 0.0348 | 0.221 | −0.465 | −0.48 | 70.4 | 0.4 |
| 80 | 3.477 | 1.074 | 0.7967 | 0.0813 | 0.297 | −0.419 | −0.71 | 80.3 | 0.3 |
| 90 | 3.691 | 1.230 | 0.8604 | 0.1277 | 0.360 | −0.372 | −0.97 | 89.1 | −0.9 |
| 100 | 3.848 | 1.504 | 0.9071 | 0.2093 | 0.407 | −0.291 | −1.40 | 99.5 | −0.5 |
| 110 | 3.984 | 1.738 | 0.9476 | 0.2790 | 0.448 | −0.221 | −2.02 | 108.7 | −1.3 |
| 120 | 4.063 | 2.031 | 0.9711 | 0.3662 | 0.471 | −0.134 | −3.52 | 119.1 | −0.9 |
| 130 | 4.121 | 2.344 | 0.9884 | 0.4594 | 0.488 | −0.041 | −12.02 | 130.2 | 0.2 |
| 140 | 4.160 | 2.656 | 1.0000 | 0.5522 | 0.500 | 0.052 | 9.57 | 141.0 | 1.0 |
| 150 | 4.043 | 2.969 | 0.9652 | 0.6454 | 0.465 | 0.145 | 3.20 | 152.4 | 2.4 |
| 160 | 3.945 | 3.242 | 0.9360 | 0.7267 | 0.436 | 0.227 | 1.92 | 162.5 | 2.5 |
| 170 | 3.789 | 3.496 | 0.8896 | 0.8023 | 0.390 | 0.302 | 1.29 | 172.8 | 2.8 |
| 180 | 3.613 | 3.711 | 0.8372 | 0.8663 | 0.337 | 0.366 | 0.92 | 182.4 | 2.4 |
| 190 | 3.398 | 3.848 | 0.7731 | 0.9071 | 0.273 | 0.407 | 0.67 | 191.1 | 1.1 |
| 200 | 3.125 | 3.984 | 0.6919 | 0.9476 | 0.192 | 0.448 | 0.43 | 201.8 | 1.8 |
| 210 | 2.871 | 4.063 | 0.6163 | 0.9711 | 0.116 | 0.471 | 0.25 | 211.1 | 1.1 |
| 220 | 2.578 | 4.121 | 0.5290 | 0.9884 | 0.029 | 0.488 | 0.06 | 221.6 | 1.6 |
| 230 | 2.246 | 4.160 | 0.4302 | 1.0000 | −0.070 | 0.500 | −0.14 | 232.9 | 2.9 |
| 240 | 1.953 | 4.093 | 0.3430 | 0.9801 | −0.157 | 0.480 | −0.33 | 243.1 | 3.1 |
| 250 | 1.699 | 3.965 | 0.2673 | 0.9419 | −0.233 | 0.442 | −0.53 | 252.8 | 2.8 |
| 260 | 1.406 | 3.828 | 0.1801 | 0.9012 | −0.320 | 0.401 | −0.80 | 263.4 | 3.6 |
| 270 | 1.191 | 3.652 | 0.1161 | 0.8488 | −0.384 | 0.349 | −1.10 | 272.7 | 2.7 |
| 280 | 1.016 | 3.438 | 0.0640 | 0.7851 | −0.436 | 0.285 | −1.53 | 281.8 | 1.8 |
| 290 | 0.898 | 3.184 | 0.0289 | 0.7094 | −0.471 | 0.209 | −2.25 | 291.0 | 1.0 |
| 300 | 0.820 | 2.930 | 0.0057 | 0.6338 | −0.494 | 0.134 | −3.69 | 299.9 | −0.1 |
| 310 | 0.801 | 2.637 | 0.0000 | 0.5466 | −0.500 | 0.047 | −10.73 | 309.7 | −0.3 |
| 320 | 0.801 | 2.305 | 0.0000 | 0.4478 | −0.500 | −0.052 | 9.57 | 321.0 | 1.0 |
| 330 | 0.840 | 2.012 | 0.0116 | 0.3605 | −0.488 | −0.139 | 3.50 | 330.9 | 0.9 |
| 340 | 0.918 | 1.738 | 0.0348 | 0.2790 | −0.465 | −0.221 | 2.10 | 340.4 | 0.4 |
| 350 | 1.074 | 1.445 | 0.0813 | 0.1917 | −0.419 | −0.308 | 1.36 | 351.4 | 1.4 |
| 0 | 1.230 | 1.230 | 0.1277 | 0.1277 | −0.372 | −0.372 | 1.00 | 0.0 | 0.0 |

The difference between the actual angle and the calculated angle varied between +3.6 degrees and −1.6 degrees, with an average delta of 0.9 and a standard deviation of 1.4.

After a predetermined number of rotations or at a time determined by an operator, swivel assembly 100 may be “zeroed out” to recalibrate swivel assembly 100. Such recalibration may be accomplished by recalibrating swivel assembly 100 against the external reference encoder discussed above.

While the equations and tables above refer to rotational angles, those skilled in the art will recognize that an exemplary embodiment of the present invention may be used to determine the position of an aerial relative to a fixed point, and the position of a particular aerial configuration may be correlated to the rotational position of target 122 with respect to housing 130. The resolver of the present invention is comparable to high-grade commercially available 12 bit (4096 steps) encoders in terms of resolution and repeatability.

The rotational angles that are sensed and calculated above are not the primary consideration in determining location of the aerial relative to fixed points, such as on the vehicle that carries the aerial. Instead, the angles are used in conjunction with the physical parameters of the aerial that is being rotated by swivel assembly 100 in order to determine the physical location of the aerial relative to those fixed points.

Referring to FIGS. 2 and 3, an interlock 142 is operatively coupled to body 120 and to processor 140 to determine when swivel assembly 100 is approaching a critical location and to prevent rotation of body 120 relative to housing 130 when a calculated value of the rotational position of target 122 with respect to housing 130 reaches a predetermined value. In step 590 of the flow chart 500 if FIG. 5, processor 140 determines whether swivel assembly 100 has rotated to a position that achieves the predetermined value. If the predetermined value has not been reached, body 120 continues to rotate. In step 600, when the predetermined value is reached, a signal is transmitted to processor 140 to stop rotation of body 120. In addition to processor 140 stopping rotation of body 120, processor 140 may also transmit a signal to an audible alarm (not shown) to provide an audible warning to the operator that the critical location has been reached.

Rotational position of target 122 relative to housing 130 is calculated by processor 140 approximately eight (8) times per second. The above-described calculations are repeated, and as the rotational position of target 122 is determined, processor 140 determines whether to continue rotating body 120 or whether interlock 142 is to be engaged to stop rotation. Examples of controllers that may be incorporate interlock 142 are disclosed in U.S. Pat. Nos. 5,780,936 and 6,104,098, which are incorporated herein by reference. Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A rotational positioning system comprising:
a housing;
a body rotatable with respect to the housing;
a target eccentrically mounted on the body;
a first sensor mounted on the housing, the first sensor adapted to transmit a first signal based on a distance of the target relative to the first sensor, the first signal varying according to a rotational position of the body with respect to the housing; and
a processor electrically coupled to the first sensor and adapted to read the first signal from the first sensor.

2. The rotational positioning system according to claim 1, wherein the first sensor is removably mounted on the housing.

3. The rotational positioning system according to claim 1, wherein the first sensor extends from the housing toward the target.

4. The rotational positioning system according to claim 1, further comprising a second sensor mounted on the housing adapted to transmit a second signal to the processor based on the distance of the target relative to the second sensor.

5. The rotational positioning system according to claim 4, wherein the second sensor is mounted on the housing at a position approximately 90 degrees from the first sensor.

6. The rotational positioning system according to claim 4, wherein the second sensor is electrically coupled to the processor such that the processor processes signals transmitted from each of the first and second sensors, the signals determining the rotational position of the body with respect to the housing.

7. The rotational positioning system according to claim 1, further comprising a second sensor mounted on the housing adapted to transmit a second signal to the processor based on a rotational direction of the target relative to the housing.

8. The rotational positioning system according to claim 1, further comprising an interlock operationally coupled to the body to prevent rotation of the body relative to the housing if the rotational position of the target with respect to the housing reaches a predetermined value.

9. The rotational positioning system according to claim 1, wherein the target has an eccentricity relative to the body of approximately 0.5 inches.

10. The rotational positioning system according to claim 1, wherein the body is mounted within a periphery of the housing.

11. A rotational positioning system comprising:
a housing;
a body rotationally mounted with respect to the housing;
a first sensor coupled to one of the housing and the body, the first sensor adapted to transmit a first signal based on a rotational position of the body relative to the housing; and
a processor electrically coupled to the first sensor to determine the rotational position of the body with respect to the housing based on the signal transmitted by the first sensor.

12. The rotational positioning system according to claim 11, wherein the body comprises a target eccentrically mounted to the body.

13. The rotational positioning system according to claim 11, further comprising a second sensor coupled to one of the housing and the body, the second sensor adapted to transmit a second signal based on a location of the body relative to the housing.

14. The rotational positioning system according to claim 13, wherein the processor is electrically coupled to the second sensor and is configured to process the signals transmitted by each of the first and second sensors to determine the rotational position of the body with respect to the housing.

15. A rotational positioning system for determining a rotational position of a body relative to a fixed point comprising:
means for obtaining a first position value;
means for obtaining a second position value;
means for determining a rotational position value based on the first position value and the second position value; and
means for determining the rotational position of the body relative to the fixed point based on the rotational position value.

16. The rotational positioning system according to claim 15, further comprising means for preventing rotation of the body when the rotational position value reaches a predetermined value.

17. A method for use with a first sensor and a second sensor of determining a rotational position of a body relative to a fixed point comprising:
a) obtaining a first output value from the first sensor;
b) obtaining a second output value from the second sensor;
c) determining a rotational position value based on the first output value and the second output value; and
d) determining the rotational position of the body relative to the fixed point based on the rotational position value.

18. The method according to claim 17, further comprising, between steps a) and c), adjusting the first output value by a constant to obtain a first calculated value.

19. The method according to claim 18, further comprising, between steps b) and c), adjusting the second output value by the constant to obtain a second calculated value.

20. The method according to claim 19, further comprising dividing the first calculated value by the second calculated value to obtain a ratio.

21. The method according to claim 20, further comprising using the ratio to determine the rotational position value.

22. The method according to claim 17, further comprising rotating the body relative to the fixed point and repeating steps a) through d).

23. The method according to claim 22, further comprising, after determining the rotational position of the body based on the rotational position value, determining whether to continue rotating the body relative to the fixed point.
